(19) United States
(12) Patent Application Publication
(10) Pub. No.: US 2013/0264945 A1
(43) Pub. Date: Oct. 10, 2013

(54) LIGHT EMITTING DIODE DRIVER WITH OVERLOAD PROTECTION AND INDICATION WITH REDUNDANCY

(71) Applicants: AL SMITH, DICKSON, TN (US); FREDERIC GRAHAM, STATE COLLEGE, PA (US)

(72) Inventors: AL SMITH, DICKSON, TN (US); FREDERIC GRAHAM, STATE COLLEGE, PA (US)

(21) Appl. No.: 13/857,113

(22) Filed: Apr. 4, 2013

Related U.S. Application Data
(60) Provisional application No. 61/620,157, filed on Apr. 4, 2012.

(51) Int. Cl. H05B 33/08

(52) U.S. Cl. CPC H05B 33/0842
USPC 315/130; 315/307

(57) ABSTRACT

A method of driving a light-emitting diode (LED) light load is disclosed herein. The method includes the step of driving an LED light load in a plurality of different modes. Each mode is defined by at least one of constant current and constant voltage delivered by a power supply. In the exemplary embodiment disclosed herein, each mode can be defined by at least one of constant current and constant voltage and by at least one of variable current and variable voltage.

### CROSS-REFERENCE TO RELATED APPLICATIONS

This application claims the benefit of U.S. Provisional Patent Application Ser. No. 61/620,157 for an LED DRIVER WITH OVERLOAD PROTECTION AND INDICATION WITH REDUNDANCY, filed on Apr. 4, 2012, which is hereby incorporated by reference in its entirety.

### BACKGROUND OF THE INVENTION

1. Field of the Invention

The invention relates to a light emitting diode (LED) power supply for powering LED lighting in electronic signs or general lighting.

2. Description of Related Prior Art

The electrical current requirements of an LED lighting string can vary significantly with changes in ambient temperature. For instance, the LEDs may operate normally when assembled in an electrical sign in a manufacturing environment, but when the sign is installed outside, the combination of sunlight and hot summer temperatures may require higher current from the driver. This might cause LED current to increase beyond the maximum rated current (that is, “overload”) of the LED driver. For this reason, most LED drivers are designed to either shut down or enter a “burst” mode to prevent overheating of the driver when it becomes overloaded. To prevent this undesirable shut down, many LED driver manufacturers suggest significant under-loading of their products, preventing full utilization of the LED driver.

Many LED drivers qualify as “Class 2” power supplies under a definition in the National Electrical Code. Such devices may be certified by Underwriters Laboratories to be Class 2 rated. Class 2 power supplies are characterized by their limited output voltage, current, and volt-amperes. These power supplies are required to have very robust electrical isolation between their relatively high input voltage (i.e., 120 VAC to 277 VAC) and their low output voltage. All these characteristics result in a product that practically eliminates the potential for electrical shock, even if the product fails. Maintaining the limited output voltage, current, and volt-amperes under conditions of abnormal output loading and component failure is difficult.

### SUMMARY OF THE INVENTION

In summary, the invention is a method of driving a light-emitting diode (LED) light load is disclosed herein. The method includes the step of driving an LED light load in a plurality of different modes. Each mode is defined by at least one of constant current and constant voltage delivered by a power supply. In the exemplary embodiment disclosed below, each mode can be defined by at least one of constant current and constant voltage and by at least one of variable current and variable voltage.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a first schematic portion of a circuit associated with an exemplary embodiment of the invention;

FIG. 2 is a second schematic portion of a circuit associated with an exemplary embodiment of the invention;

FIG. 3 is a third schematic portion of a circuit associated with an exemplary embodiment of the invention; and

FIG. 4 is a schematic of a replacement circuit portion for providing an indication of desired operation and/or an indication of a possible overload condition.

### DETAILED DESCRIPTION OF AN EXEMPLARY EMBODIMENT

The exemplary embodiment can drive an LED light load in a plurality of different modes, wherein each mode is defined by at least one of constant current and constant voltage delivered by a power supply. In some embodiments of the broader invention, such as the exemplary embodiment, a circuit can drive an LED light load in a plurality of different modes, wherein each mode is defined by at least one of constant current and constant voltage and by at least one of variable current and variable voltage. In a first example, the LED light load can be driven in a first mode defined by constant voltage and variable current delivered by a power supply. In a second example, the LED light load can be driven in a second mode defined by variable voltage and constant current. The step of driving the LED light load in the second mode can occur after the step of driving the LED light load in the first mode.

At least some embodiments of the invention effectively operate to prevent LED overloading by limiting output current to a value slightly higher than its output current rating. This has the effect of lowering the LED driver output voltage, but does not turn off or flash the LED load, which could be a nuisance to the user. In most cases, the end affect of a potential overload is a slight dimming of the LED light source. An indicator light may be incorporated in one or more embodiments of the invention which, when it lights, can indicate a potential overload of the LED driver has occurred.

An LED driver according to some embodiments of the broader invention may incorporate one or more levels of redundancy. Such level(s) of redundancy allow the power supply to either continue to operate normally or to enter safe operating modes within the limits of Class 2 operation, even when critical circuit components fail.

Embodiments of the invention can be applied to solve the problem of power supply shutdown due to levels of high current draw causing high internal heat generation. The solution provided by the exemplary embodiment is arrived at by allowing the current to climb as the LED's forward voltage begins to decrease but only letting the current climb until it reaches the design limit of the power supply. At this time the exemplary embodiment avoids burst mode or shutdown of the power supply by decreasing the drive voltage. It is noted that heat is generated by power which is voltage times current, so in light of constant current the approach is to reduce drive voltage thereby keeping the power (and the heat) below the design threshold. As the temperature continues to climb, the voltage continues to drop while the current remains constant. At some point, however, the voltage decreases to a point where the constant current control circuit is no longer functional. At that time, the exemplary embodiment can deliver voltage that is effectively fixed and the current may begin to increase again. While the exemplary embodiment desirably reduces the likelihood of this occurring, once the current reaches a maximum rated value the circuit may shut down.

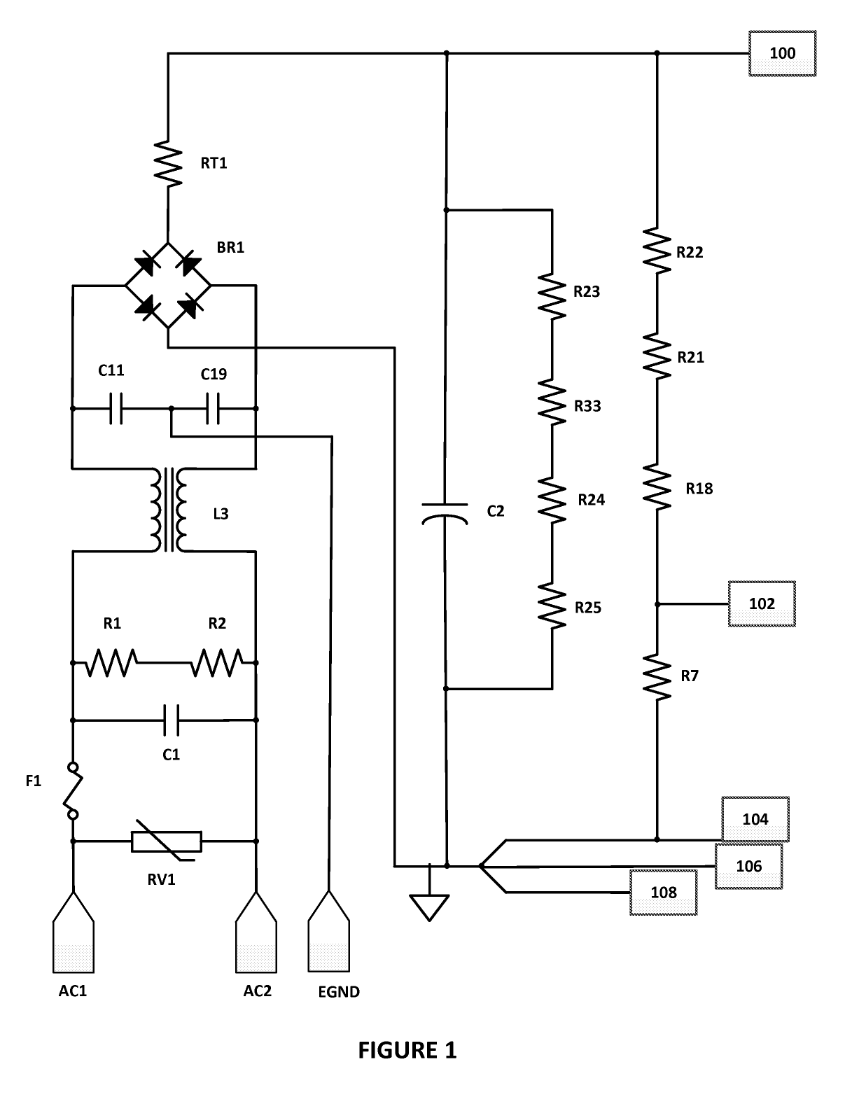

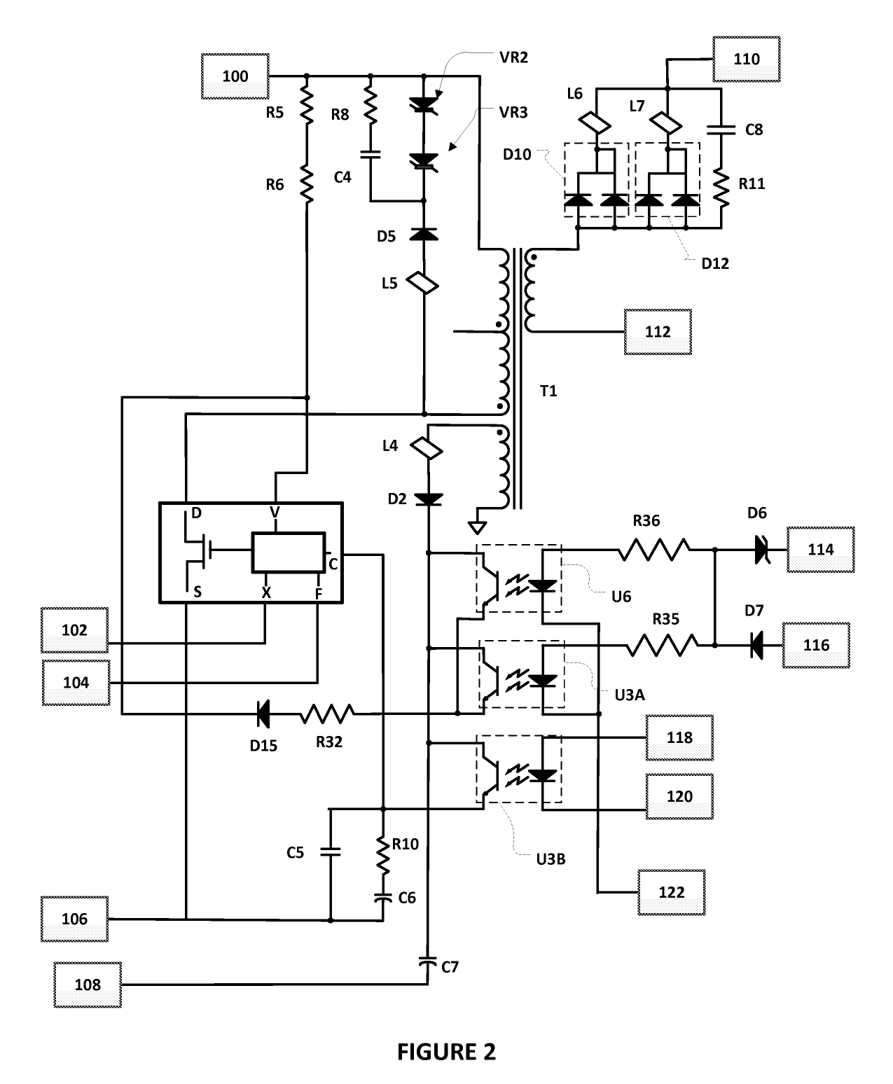

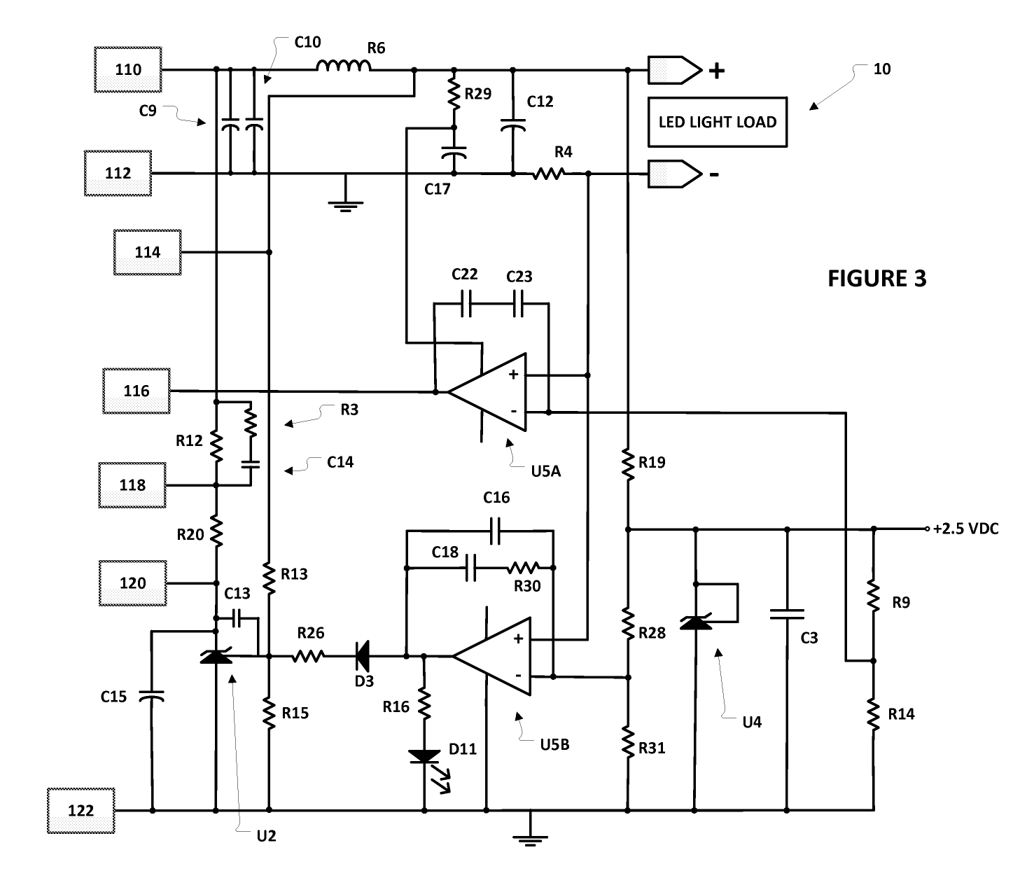

Referring now to the drawings wherein the showings are for purposes of illustrating embodiments of the invention only and not for purposes of limiting the same, FIGS. 1-3 show a circuit schematic that drives an LED light load 10, shown in FIG. 3. When the LED light load 10 requires less than, or equal to, the rated output current of the power supply, the power supply produces its rated output voltage (a “constant voltage” output). Output voltage regulation is maintained by sampling power supply output voltage via resistor divider composed of R13 and R15. The values of R13 and R15 are chosen so that voltage across R15 is equal to the reference pin voltage of IC U2.

This represents a first mode of operation, defined by constant design voltage and varying current. This constant design level can be viewed as a first voltage level and can be predetermined. R13 and R15 (a voltage divider with R13 connected to 12 VDC and R15 connected to ground) in FIG. 3 are creating a voltage that is linearly dependent to the 12 VDC output voltage. This dependent voltage drives a regulator U2 which turns on or off U3B to communicate to the main controller U1 that more or less voltage is needed. R12, R3, C14, R20, C13, C15, U2, R13, R15, and U3B exist for this purpose; that is, to control and keep the output voltage at 12 VDC, operating as the voltage feedback circuit to U1. Current varies because of temperature increases and corresponding voltage drops across the LED light load 10.

In a second mode of operation following the first mode described above, the current can be monitored as it climbs to the rated current of the power supply or slightly more current than the power supply's maximum rated output current. The current can rise to a first current level. When the LED light load 10 requires slightly more current than the power supply's maximum rated output current, the power supply goes into the second mode or the “constant current” mode. The supply voltage varies (decreases) as the current remains substantially constant in the second mode of operation. The output supply voltage can progressively decrease. As even more LED's are connected, the power supply output voltage decreases to maintain a constant current into the LED's. This is facilitated by the action of the output current sensing circuit consisting of R4, voltage reference U4, and op amp U5B (and their associated components), which modify the voltage feedback circuit heretofore described in paragraph 16). This allows for the very precise maintenance of that constant current output until a decreasing load resistance pulls the power supply output voltage down to a very low level. In the 12 VDC power shown schematically, this is approximately 4.5 volts.

The current sense resistor, R4, has the load current passing through it. When 5.3 A is passing through R4 the voltage across R4 will be 53 mV in the exemplary embodiment. This is connected to pin 5 of U5B. On pin 6 of U5B is another voltage divider. U4 acts as a voltage reference and can create 2.495 VDC without regard to the reasonably—expected range of voltage provided through R19 in the exemplary embodiment. This is divided by the voltage divider R26 and R31 such that 53 mV can be delivered to pin 6 of U5B. U5B is an op-amp with a high gain. Because of this high gain the voltage at pin 7 is a value substantially close to the supply voltage, 12 VDC probably 11.5V. Therefore, when the voltage at pin 5 of U5B exceeds the 53 mV at pin 6 of U5B by any appreciable amount the output turns on and drives the U2 regulator thereby causing the U1 controller to view the voltage as too high and thereby reducing the output voltage. The opamp feedback consisting of C16, C18, and R30 operate to filter out a noisy signal which can be especially problematic when the maximum current is getting really close to the limit. R16 exists to limit the current through D11. D11 is an indicator LED that lets the user know that the system is operating in this Mode B, indicating a potential problem. D3 exists to prevent the first mode constant voltage control from turning on D11. R28 limits the output current of U5B.

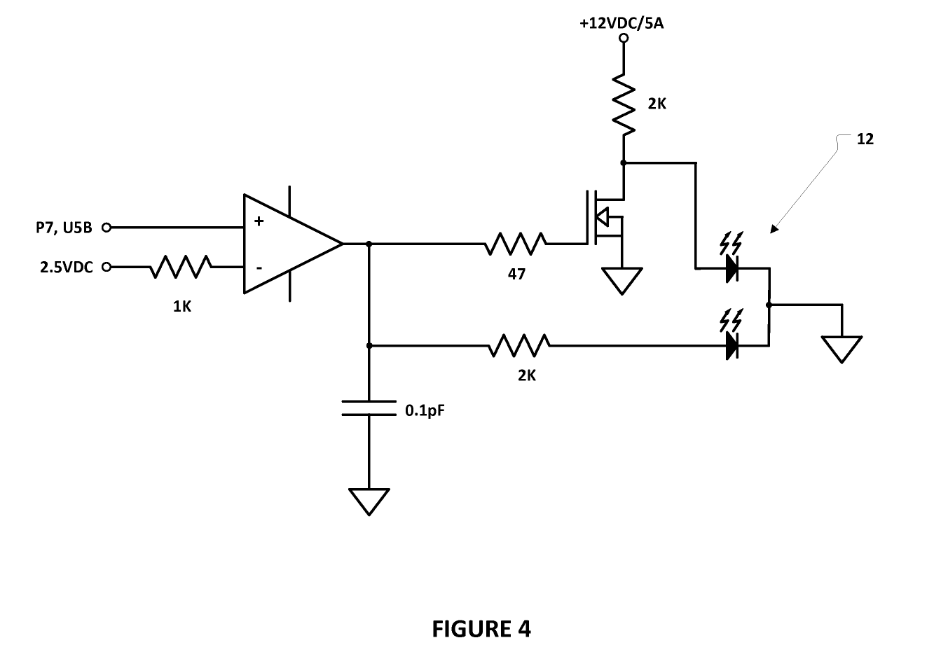

Light emitting diode D11 indicates when an attempted overload is occurring. Referring to last paragraph, when the power supply enters its “constant current” mode, the output voltage of OPAMP U5B is sufficient to light D11. As long as a constant current condition remains, this diode will remain lit, unless the main control IC U1 latches off. For an indication of both “normal” and attempted overload condition, resistor R16 and diode D11 removed and replaced with the circuit shown in FIG. 4, having two visual indicators such as multiple LEDS or, for example, a Bi-color LED 12. One of the LEDs can illuminate when the power supply is in constant voltage output mode and the other LED can illuminate when the power supply is in constant current output mode.

The LED driver load status indication accomplished by D11 can be further enhanced by lighting one color indicator light when the power supply is operating at or below rated output current and a different color indicator light when an attempt to overload the LED driver has occurred. These two load states can also be indicated by a single light that flashes codes for normal load and attempted overload.

Once the voltage drops so low that the bias voltage created between R13 and R15 is no longer enough to drive U2 then the current begins to rise again. Since bias for the constant output voltage control circuit is derived from power supply output voltage, the current control feedback coming from OPAMP U5B becomes less effective, so the output current limit starts to increase beyond 5.25-5.35 amps limit since insufficient output voltage remains to produce the required feedback current to optocoupler U3B to drive the output voltage down further. This represents a third mode of operation defined by constant, relatively low voltage and varying, relatively high current. This second level of voltage is different than the first level of voltage described above and associated with the first mode of operation. However, the voltage remains high enough to operate the OPAMPs and optocoupler U3A, since 2.5-volt drop across the voltage reference/error amplifier U2 is absent in this circuit.

During the third mode of operation, the current sense resistor R4 can provide a voltage of more than 65 mV (because our current is rising) to pin 3 of U5A. Another divided voltage is provided to pin 2 by R14 and R9. C3 acts to filter noise from the input to pin 2 while C22 and C23 act to filter noise out of the action of U5A in shutting this system down. When the current is above 7.126 A in the exemplary embodiment, the voltage at pin 1 of U5A rises and delivers current to U3A which controls the V pin on U2 causing the system to shut down. U6, R36, and D6 can protect the system from a voltage of more than 15 VDC. If that were to happen, the zener diode Z6 conducts backwards at 15V or above and turns on U6 which turns off U2.

As the load resistance decreases further, the output current also increases until 6.5 amps is reached. (Even so, the output power at this time is quite low—far below the 100 VA limit). At this point, the comparator/optoisolator circuit consisting of U5A and U3A and associated components comes into play, forcing current into U3A, which, in turn, latches off the main control IC U1. This defines a fourth mode of operation, in which shutdown or bursting occurs.

Many levels of redundancy are shown in the exemplary feedback circuit. This may be important in some operating environments since, even when some component in the feedback circuit fails, the power supply output should remain within Class 2 limits. To understand these redundancy features, it is helpful to know about some of the safety shutdown features of the main control IC U1. Pin 1 on U1 is used to shut down the power supply when current into the pin exceeds a certain level. U1 also has a feature that causes the power supply to enter a self-protecting “burst” mode when a predetermined peak transformer primary current is exceeded. This current limit is set at a level which will not allow the power supply's output current to ever exceed the maximum allowed for Class 2 operation). This is detected via Pin 6. Current to initially power IC U1 is derived from the main DC bulk voltage via R5 and R6; however, for normal operation to commence, a current must flow into Pin 3 of U1 from a DC auxiliary voltage derived from winding 5-6 of the power transformer, rectified by diode D2 and filtered by capacitor C7. If this current does not flow into Pin 3, a safe “burst” mode is initiated.

The exemplary embodiment also provides additional examples of redundancy, as variable resistor RT1 is connected to the output terminals of the power supply and the value of RT1 is being progressively dropping with increasing temperature. The circuit which includes D6, R36, and U6 can shut down the power supply if under some failure mode the output voltage tends to exceed 15 volts, which might cause failure of the LED lights connected to the power supply output. If the power supply output voltage exceeds 15 volts, current flows through D6, R36, and the diode of U6, turning on the U6 photo-transistor which injects a current into pin 1 of U1, shutting down the power supply. If now the U6 diode shorts or opens, this circuit will continue to operate since current through diode D6 will now flow through R35 and U3A. Likewise, if the diode in U3A shorts or opens, the 6.5 amp current shut down will be maintained via R36 and U6.

If U5A or U5B fail, this implies that the whole U5 integrated circuit has failed, in which case the constant current feedback through U5B is lost. In this situation, as the load resistance progressively decreases the output voltage will remain constant, so the output current will correspondingly increase; however, at the predetermined maximum peak transformer primary current the power supply will be shut down by U1.

If IC U2 is shorted, IC U1 is forced to maintain minimum power supply output voltage due to maximum current flow through U3B diode. Output current will be limited to 6.5 Amps by the action of U5A and U3A. U1 will then cause a safe “burst” mode at the power supply's output.

If U2 opens, IC U1 will again initiate a burst mode since operating current for U1 cannot be provided when U3B photo-transistor is not conducting. If R13 or R15 opens, the power supply will operate in the same manner as the U2 shorted or U2 open conditions. If U6's photo-transistor or LED opens, the driver will function properly due to redundancy afforded by U3A. If U6's photo-transistor shorts, U1 will initiate burst mode. If U3A's photo-transistor opens, the power supply will function properly due to redundancy path through U6. If U3A's photo-transistor shorts, U1 will initiate burst mode. If the U3B diode shorts or opens, U1 will initiate burst mode because operating current for U1 cannot be provided when U3B photo-transistor is not conducting. If U3B's photo-transistor opens, U1 will initiate burst mode because operating current for U1 cannot be provided when U3B photo-transistor is not conducting. If U3B's photo-transistor shorts, U1 will be triggered into burst mode if and when output exceeds 6.5 amps through action of U5A and U6 or U3A. If U4 opens, U1 will enter primary current limit burst mode if output exceeds 7 amps. If U4 is shorted, U1 will be shut down through operation of U5A, and U6 or U3A. If U5 output becomes latched high, U1 will be shut down through action of U6 or U3A. If U5 output becomes latched low: U1 will go into primary current limit burst mode if output exceeds 7 amps. If U5 is floating: U1 will go into primary current limit burst mode if output exceeds 7 amps.

Immediately below is a table of exemplary components that can be applied in at least some embodiments of the broader invention:

| Component | Value or Part No. | Component | Value or Part No. |
|---|---|---|---|
| Resistor R1 | 1.5 MΩ | Capacitor C1 | 330 nF |
| R2 | 1.5 MΩ | C2 | 100 μF |
| R3 | 162 kΩ | C3 | 10 nF |
| R4 | 0.01 Ω | C4 | 680 pF |
| R5 | 2.0 MΩ | C5 | 100 nF |
| R6 | 2.0 MΩ | C6 | 47 μF |
| R7 | 17.8 kΩ | C7 | 22 μF |
| R8 | 75 | C8 | 2200 pF |
| R9 | 10 kΩ | C9 | 470 μF |
| R10 | 6.8 kΩ | C10 | 470 μF |
| R11 | 5.11 kΩ | C11 | 2.2 nF |
| R12 | 510 kΩ | C12 | 220 μF |
| R13 | 17.8 kΩ | C13 | 100 nF |
| R14 | 294 | C14 | 10 nF |
| R15 | 4640 | C15 | 4.7 μF |
| R16 | 162 | C16 | 1000 pF |
| R18 | 3 MΩ | C17 | 4.7 μF |
| R19 | 2.21 kΩ | C18 | 100 nF |
| R20 | 10 kΩ | C19 | 2.2 nF |
| R21 | 3 MΩ | C22 | 2200 pF |
| R22 | 3 MΩ | C23 | 2200 pF |
| R23 | 1 MΩ | Thermally-variable | 10 (Ohms, rated) |
| | | Resistor, RT1 | |
| R24 | 1 MΩ | Fuse F1 | 2 Amps |
| R25 | 1 MΩ | Varistor RV1 | S14K320 |
| R26 | 1 kΩ | Zenner Diode VR2 | P6KE91A |
| R28 | 10 kΩ | VR3 | P6KE91A |
| R29 | 10 kΩ | Inductive Element | 1 μH |
| | | L2 | |
| R30 | 10 kΩ | L3 | 10 mH |
| R31 | 249 | L4-L7 | n/a, Amobeads |
| R32 | 5.11 kΩ | Diode D2 | BAU21 |
| R33 | 1 MΩ | D3 | FDH333 |
| R35 | 2.21 kΩ | D5 | UF1006 |
| R36 | 2.21 kΩ | D7 | MMBD4146 |
| Integrated | TOP271 | D10, D12 | STPS4021OCT |
| Circuit/ | | | |
| Transistor, | | | |
| U1 | | | |
| U2 | TL431 | D11 | LED |
| U3A, B | LTV827SD | D15 | 1N4148 |
| U4 | TL431 | Transformer T1 | EER28L |
| U5A, B | LM258S0 | | |
| U6 | LTV817SD | | |

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Further, the “invention” as that term is used in this document is what is claimed in the claims of this document. The right to claim elements and/or sub-combinations that are disclosed herein as other inventions in other patent documents is hereby unconditionally reserved.

What is claimed is:

1. A method of driving a light-emitting diode (LED) light load comprising the steps of:
driving an LED light load in a plurality of different modes, wherein each mode is defined by at least one of constant current and constant voltage delivered by a power supply.

2. The method of claim 1 wherein said driving step is further defined as:
driving the LED light load in a plurality of different modes, wherein each mode is defined by at least one of constant current and constant voltage and by at least one of variable current and variable voltage.

3. The method of claim 2 wherein said driving step further comprises:
driving the LED light load in a first mode defined by constant voltage and variable current.

4. The method of claim 3 wherein said driving step further comprises:
driving the LED light load in a second mode defined by variable voltage and constant current.

5. The method of claim 4 wherein said step of driving the LED light load in the second mode occurs after said step of driving the LED light load in the first mode.

6. The method of claim 1 wherein said driving step further comprises:
driving the LED light load in a first mode defined by constant voltage at a first voltage level; and
driving the LED light load in a second mode defined by constant voltage at a second voltage level different than the first voltage level.

7. The method of claim 6 wherein said driving step further comprises:
driving the LED light load in a third mode defined by variable voltage.

8. The method of claim 7 wherein said step of driving the LED light load in the second mode occurs after said step of driving the LED light load in the first mode and after said step of driving the LED light load in the third mode.

9. The method of claim 1 wherein said driving step further comprises:
monitoring current drawn from the power supply; and
varying output voltage of the power supply in response to changes in the current monitored during said monitoring step.

10. The method of claim 9 wherein said varying step further comprises:
reducing output voltage after current rises to first predetermined level.

11. The method of claim 10 wherein said reducing step further comprises:
reducing output voltage to a second predetermined level after current rises to first predetermined level.

12. The method of claim 11 further comprising:
maintaining the output voltage at the second predetermined level as current rises from the first predetermined level.

13. The method of claim 1 further comprising:
providing a visual indicator that illuminates when the power supply is delivering constant output voltage.

14. A method of driving a light-emitting diode (LED) light load comprising the steps of:
driving an LED light load in a first mode in which a power supply delivers a substantially constant output voltage at a first voltage level;
determining that an output current of the power supply has exceeded a first current level during said step of driving the LED light load in the first mode;
driving the LED light load in a second mode in response to said determining step, wherein during the second mode the power supply delivers a progressively decreasing level of output voltage, down to a second voltage level less than the first voltage level;
substantially holding the output current at the first current level during at least part of said step of driving the LED light load in the second mode;
substantially holding the output voltage at the second voltage level after said step of driving the LED light load in the second mode; and
allowing the output current to increase above the first current level during said step of substantially holding the output voltage at the second voltage level.

15. The method of claim 14 further comprising:
providing a first visual indicator that illuminates when the power supply is delivering constant output voltage; and
providing a second visual indicator that illuminates when the power supply is delivering constant output current.
